(19) United States
(12) Patent Application Publication
(10) Pub. No.: US 2013/0027522 A1
(43) Pub. Date: Jan. 31, 2013

(54) STEREOSCOPIC IMAGING APPARATUS

(71) Applicants: Masahiro Yamada, Kanagawa (JP); Sunao Aoki, Kanagawa (JP)

(72) Inventors: Masahiro Yamada, Kanagawa (JP); Sunao Aoki, Kanagawa (JP)

(73) Assignee: SONY CORPORATION, Tokyo (JP)

(21) Appl. No.: 13/551,922

(22) Filed: Jul. 18, 2012

(30) Foreign Application Priority Data
Jul. 26, 2011 (JP) 2011-163245

(51) Int. Cl. H04N 13/02

(52) U.S. Cl. 348/47; 348/E13.074

(57) ABSTRACT

A stereoscopic imaging apparatus includes: an objective optical system acquiring light rays emitted from a subject and guiding the light rays to a downstream component; a separation optical system having a partially reflective surface reflecting part of the light rays and transmitting part thereof; first image forming optical system disposed on a path along which the light rays reflected off the separation optical system travel and focusing the reflected light rays to form a parallax image; second image forming optical system disposed on a path along which the light rays passing through the separation optical system travel and focusing the transmitted light rays to form a parallax image; a first imaging device converting the parallax image formed by the first image forming optical system into an image signal; and a second imaging device converting the parallax image formed by the second image forming optical system into an image signal.

### CROSS-REFERENCE TO RELATED APPLICATION

The present application claims priority from Japanese Patent Application No. JP 2011-163245 filed in the Japanese Patent Office on Jul. 26, 2011, the entire content of which is incorporated herein by reference.

### FIELD

The present disclosure relates to a stereoscopic imaging apparatus that captures stereoscopic images, and particularly to a technology for reducing the distance between two lenses used to capture stereoscopic video images.

### BACKGROUND

In recent years, a camera capable of capturing 3D (stereoscopic) video images (stereoscopic imaging apparatus) is increasingly desired. An example of a known stereoscopic imaging apparatus is based on a side-by-side method in which two cameras are so disposed that lens base lines of the cameras are parallel to each other (parallel twin-lens method). A stereoscopic imaging apparatus of this type is suitable for imaging using a long baseline length (IAD: inter-axial distance) of, for example, at least 65 mm or suitable for imaging a far subject.

On the other hand, to capture an image of a near subject, the baseline length (hereinafter referred to as “IAD”) needs to be a short length ranging from about 10 to 40 mm. The reason for this is that when an image of a near subject is captured by using a long IAD, which results in a large angle of convergence of the two cameras, the depth of stereoscopic images expressed on a screen exceeds a range within which a viewer can view the stereoscopic images comfortably. In this case, the viewer who views the stereoscopic images disadvantageously feels tired, sick, or otherwise feel uncomfortable.

However, in a stereoscopic imaging apparatus based on the side-by-side method, in which optical systems and imagers of the two cameras are disposed side by side, the two cameras can physically interfere with each other, which prevents the IAD from being shorter than a minimum distance between the two cameras that is determined by the positional relationship between the optical systems and the imagers.

In contrast, a stereoscopic imaging apparatus based on a beam-splitter method (half-silvered mirror method) can use a short IAD. In a stereoscopic imaging apparatus based on a beam-splitter method, in which image light rays separated by a half-silvered mirror are directed to two imaging units, the two imaging units are so disposed that the lens optical axes thereof intersect each other at right angles at the surface of the half-silvered mirror. That is, since the two imaging units will not physically interfere with each other, the IAD can be reduced to even zero.

However, a stereoscopic imaging apparatus based on the beam-splitter method, in which the two imaging units are mounted on a base called a rig, is large and heavy as a whole. Further, the edge of the half-silvered mirror should not to appear within the field of view of each of the two imaging units, the size of the half-silvered mirror needs to be very large in proportion to the diameters of the lenses in the imaging units, which leads to increase in cost of the stereoscopic imaging apparatus. Moreover, in a stereoscopic imaging apparatus in which imaging units are mounted on a rig, setting the IAD, the angle of convergence, and other parameters and alignment and other adjustments are typically required whenever images are captured, resulting in greatly cumbersome efforts.

To solve the problems described above, an attempt has been so made in recent years to configure an integrated stereoscopic imaging apparatus by incorporating twin lenses used to capture images based on the side-by-side method in a single enclosure. The thus configured stereoscopic imaging apparatus does not typically require any assembly or alignment. Further, a stereoscopic imaging apparatus of this type, which is compact, can be readily carried in field imaging and material collecting applications and can be quickly ready for imaging in a short setup period.

JP-A-9-46729, for example, describes a stereoscopic imaging apparatus in which twin lenses are incorporated in a single enclosure.

### SUMMARY

However, the thus integrated stereoscopic imaging apparatus, which is still based on the side-by-side method, has a limitation in the IAD adjustment. That is, the minimum IAD is still limited to a certain distance determined by the positional relationship between the optical systems and imagers.

In view of the above circumstances, it is desirable to achieve imaging by using a short IAD and reduction in size of a stereoscopic imaging apparatus.

An embodiment of the present disclosure is directed to a stereoscopic imaging apparatus including an objective optical system, a separation optical system, a first image forming optical system, a second image forming optical system, a first imaging device, and a second imaging device, and the configuration and function of each of the components described above are as follow: The objective optical system acquires light rays emitted from a subject and guides the light rays to the downstream components. The separation optical system has a partially reflective surface that reflects part of the light rays guided through the objective optical system and transmits part thereof. The first image forming optical system is disposed on a path along which the light rays reflected off the separation optical system travel and focuses the reflected light rays to form a parallax image. The second image forming optical system is disposed on a path along which the light rays passing through the separation optical system travel and focuses the transmitted light rays to form a parallax image. The first imaging device converts the parallax image formed by the first image forming optical system into an image signal. The second imaging device converts the parallax image formed by the second image forming optical system into an image signal.

Since the configuration described above prevents the first and second image forming optical systems from physically interfering with each other, the IAD can be shortened. Further, placing the separation optical system in a position downstream of the objective optical system allows the size of the separation optical system to be reduced, whereby the size of the entire stereoscopic imaging apparatus can be reduced accordingly.

According to the embodiment of the present disclosure, imaging can be performed by using a short IAD and the size of the apparatus can be reduced.

### BRIEF DESCRIPTION OF THE DRAWINGS

FIGS. 1A and 1B are schematic views showing an example of the configuration of a stereoscopic imaging apparatus according to a first embodiment of the present disclosure, FIG. 1A being a side view and FIG. 1B being a top view;

FIG. 2 is an optical path diagram showing an example of the optical paths of light rays incident on image forming optical systems after traveling through an objective optical system having a image forming capability according to the first embodiment of the present disclosure;

FIGS. 3A and 3B are optical path diagrams showing examples of the optical paths of light rays incident on image forming optical systems after traveling through an objective optical system that receives light rays emitted from a subject and outputs substantially parallel light rays according to the first embodiment of the present disclosure, FIG. 3A being an optical path diagram of light rays emitted from a single point on the subject and reaching the image forming optical systems and FIG. 3B being an optical path diagram of light rays passing through the centers of lenses in the image forming optical systems;

FIGS. 4A and 4B describe an example of zooming performed in the stereoscopic imaging apparatus according to the first embodiment of the present disclosure, FIG. 4A showing an example of the positions of lenses at wide-angle low magnification and FIG. 4B showing an example of the positions of the lenses at narrow-angle high magnification;

FIGS. 5A and 5B describe an example of focusing performed in the stereoscopic imaging apparatus according to the first embodiment of the present disclosure, FIG. 5A showing a case where the focus position is moved toward a subject and FIG. 5B showing a case where the focus position is moved toward an image;

FIG. 6 is a side view showing an example of the angle at which a half-silvered mirror and one of the image forming optical systems are disposed according to the first embodiment of the present disclosure;

FIG. 7 is a side view showing an example of the configuration of a stereoscopic imaging apparatus according to Variation 1 of the first embodiment of the present disclosure;

FIGS. 8A and 8B are schematic views showing an example of the configuration of a stereoscopic imaging apparatus according to Variation 2 of the first embodiment of the present disclosure, FIG. 8A being a side view and FIG. 8B being a top view;

FIG. 9 is a side view showing an example of the configuration of a stereoscopic imaging apparatus according to Variation 3 of the first embodiment of the present disclosure;

FIGS. 10A and 10B are schematic views showing an example of the configuration of a stereoscopic imaging apparatus according to a second embodiment of the present disclosure, FIG. 10A being a top view and FIG. 10B being a side view;

FIG. 11 is a perspective view showing the example of the configuration of the stereoscopic imaging apparatus according to the second embodiment of the present disclosure;

FIGS. 12A and 12B are schematic views showing an example of the configuration of a stereoscopic imaging apparatus according to Variation 1 of the second embodiment of the present disclosure, FIG. 12A being a top view and FIG. 12B being a side view;

FIG. 13 is a perspective view showing the example of the configuration of the stereoscopic imaging apparatus according to Variation 1 of the second embodiment of the present disclosure;

FIGS. 14A and 14B are schematic views showing an example of the configuration of a stereoscopic imaging apparatus according to Variation 2 of the second embodiment of the present disclosure, FIG. 14A being a top view and FIG. 14B being a side view;

FIG. 15 is a perspective view showing the example of the configuration of the stereoscopic imaging apparatus according to Variation 2 of the second embodiment of the present disclosure; and

FIG. 16 is a top view showing an example of the configuration of a stereoscopic imaging apparatus according to a third embodiment of the present disclosure.

### DETAILED DESCRIPTION

Stereoscopic imaging apparatus according to embodiments of the present disclosure will be described below. The description will be made in the following order.

1. First Embodiment (a case where two image forming optical systems and imaging devices corresponding thereto are so disposed that optical axes thereof are parallel to each other)

2. Second Embodiment (a case where two image forming optical systems and imaging devices corresponding thereto are so disposed that optical axes thereof intersect each other)

3. Third Embodiment (a case where a plurality of image forming optical systems and imaging devices corresponding thereto are provided)

### 1. Example of Configuration of Stereoscopic Imaging Apparatus According to First Embodiment

### 1-1. Example of Configuration of Stereoscopic Imaging Apparatus

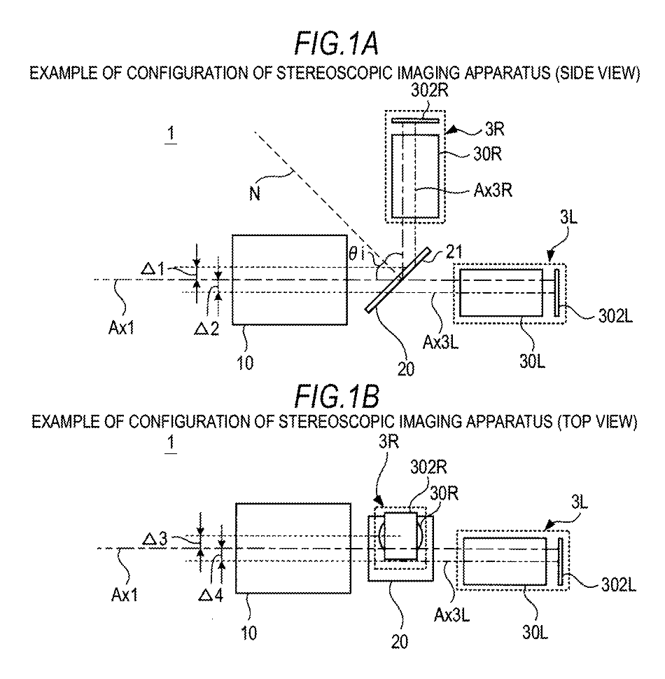

An example of the configuration of a stereoscopic imaging apparatus according to a first embodiment of the present disclosure will first be described with reference to FIGS. 1A and 1B to 5A and 5B. FIG. 1A is a side view of a stereoscopic imaging apparatus 1 according to the present embodiment, and FIG. 1B is a top view of the stereoscopic imaging apparatus 1. The stereoscopic imaging apparatus 1 includes an objective optical system 10, a half-silvered mirror 20 as a separation optical system, and imaging units 3R and 3L, as shown in FIGS. 1A and 1B.

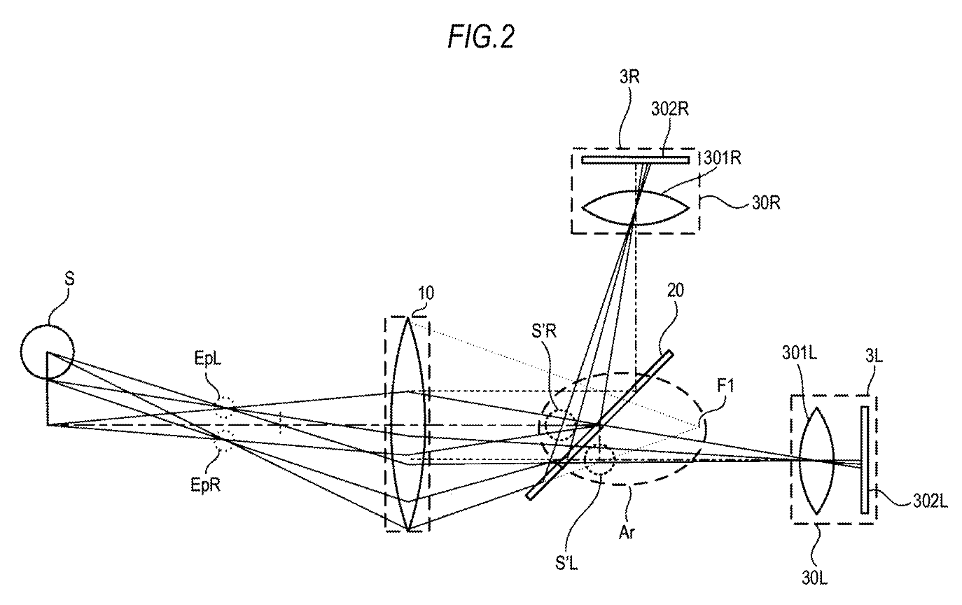

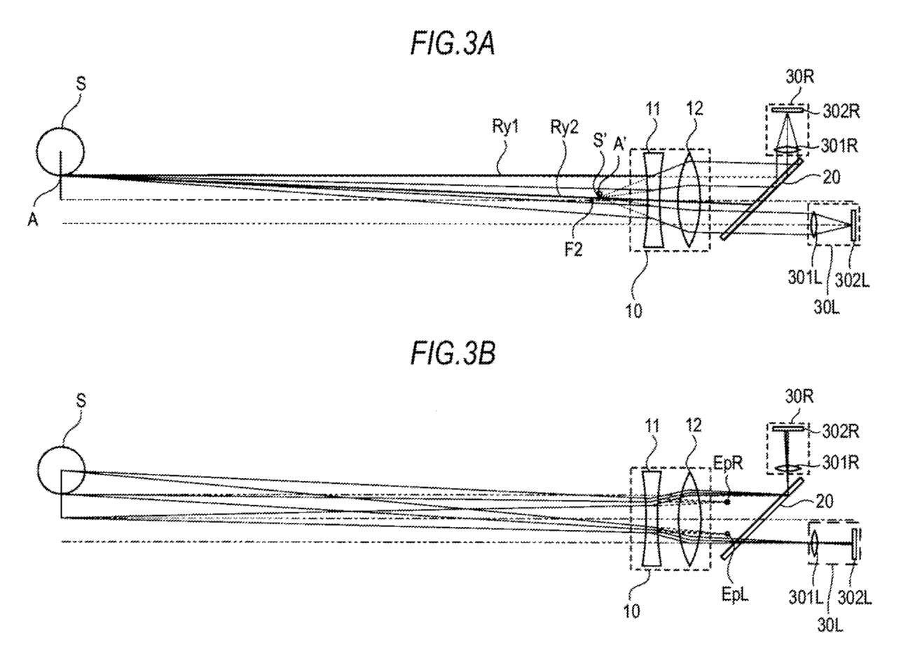

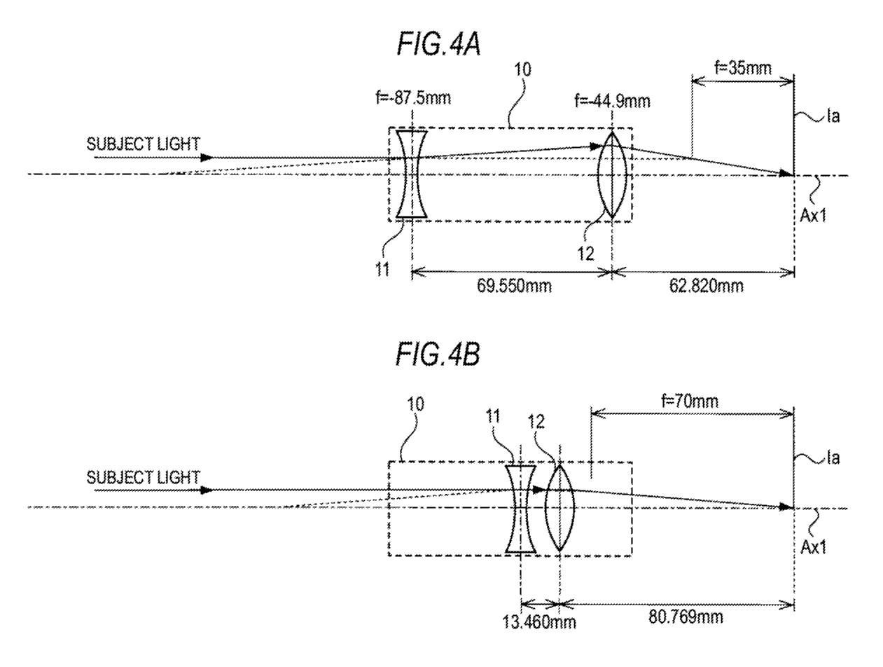

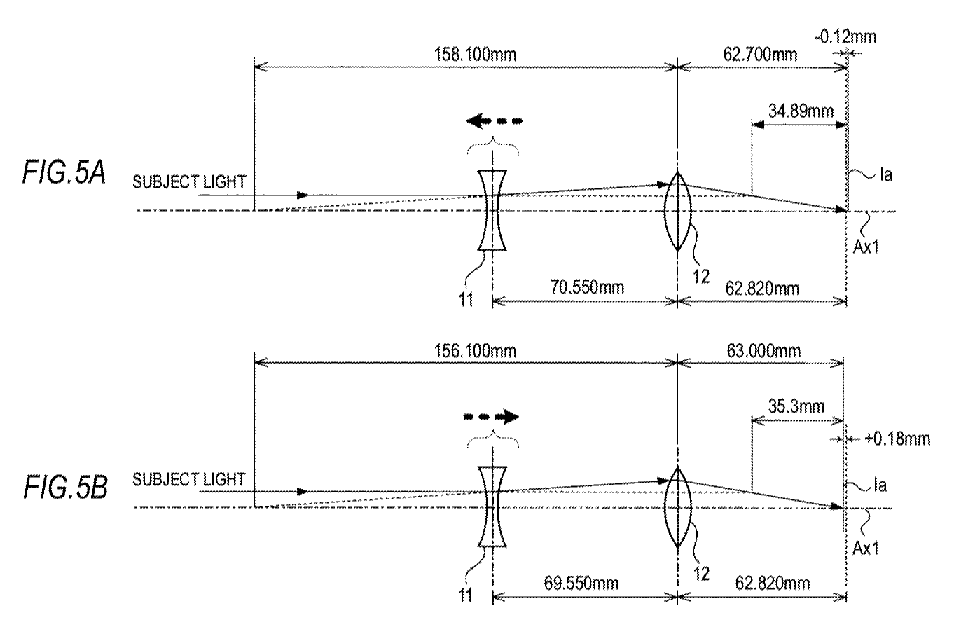

The objective optical system 10 has a large number of lens groups each including a plurality of lenses, filters, diaphragms, and lens drive mechanisms (not shown) arranged in a lens barrel indicated by the rectangular line. The objective optical system 10 acquires light emitted from a subject (not shown) and traveling from left to right in FIGS. 1A and 1B and guides the light to downstream components. Each of the lenses in the objective optical system 10 may form a real or virtual image, and the objective optical system 10 may be configured to be an afocal system that receives light rays from the subject (hereinafter also referred to as “subject light”) and outputs light rays substantially parallel to each other. The objective optical system 10 is also configured to include a zoom optical system and a focus optical system, and zooming and focusing are performed by using the lens drive mechanisms (not shown) to drive the lenses that form zoom and focus the optical systems. The lens configuration of the objective optical system 10 will be described later with reference to FIGS. 2, 3A, and 3B, and the zooming and focusing will be described later with reference to FIGS. 4A, 4B, 5A, and 5B.

The half-silvered mirror 20 has a partially reflective surface 21 formed on one surface of a transparent glass substrate, and the partially reflective surface 21 reflects part of the light rays guided through the objective optical system 10 and transmits part thereof. The ratio of the amount of reflected light to the amount of transmitted light is set at 1:1 or any other arbitrary value. The partially reflective surface 21 is formed, for example, of a semitransparent thin film made of chromium, silver, or any other suitable metal. The partially reflective surface 21 may alternatively be formed by depositing a dielectric multilayer film instead of a metal thin film. The partially reflective surface 21, when it is formed of a polarization-dependent dielectric multilayer film, handles the light incident on the half-silvered mirror 20 as follows: The partially reflective surface 21 reflects light polarized in a certain direction and transmits light polarized in the direction perpendicular to the certain direction. The partially reflective surface 21, when it is formed of a non-polarization-dependent dielectric multilayer film, reflects part of the incident light and transmits part thereof.

The angle at which the half-silvered mirror 20 is disposed is so set in the example shown in FIGS. 1A and 1B that the angle of incidence θi of a light ray traveling along an optical axis Ax1 of the objective optical system 10 and incident on the half-silvered mirror 20 is 45 degrees. The angle of incidence θi is the angle between a normal N to an incident point where a light ray traveling along the optical axis Ax1 of the objective optical system 10 is incident on the half-silvered mirror 20 and the light ray traveling along the optical axis Ax1 and incident on the half-silvered mirror 20.

The imaging unit 3R includes an image forming optical system 30R as a first image forming optical system and an imaging device 302R as a first imaging device. The image forming optical system 30R includes a plurality of lenses (not shown) and focuses the subject light reflected off the half-silvered mirror 20 on an imaging surface (not shown) of the imaging device 302R to form a parallax image. The imaging device 302R converts the parallax image formed by the image forming optical system 30R into an image signal.

The imaging unit 3L includes an image forming optical system 30L as a second image forming optical system and an imaging device 302L as a second imaging device. The image forming optical system 30L includes a plurality of lenses (not shown) and focuses the subject light having passed through the half-silvered mirror 20 on an imaging surface (not shown) of the imaging device 302L to form a parallax image. The imaging device 302L converts the subject light focused by the image forming optical system 30L into an image signal.

The image forming optical systems 30R and 30L are so angularly disposed that the optical axes thereof (optical axes Ax3R and Ax3L) are perpendicular to each other, as shown in FIG. 1A. The image forming optical system 30L is so disposed that the optical axis Ax3L thereof is parallel to the optical axis Ax1 of the objective optical system 10, and the image forming optical system 30R is so angularly disposed that the optical axis Ax3R thereof is perpendicular to the optical axis Ax1 of the objective optical system 10.

In more detail, the image forming optical system 30R is so disposed that the subject light having passed through the objective optical system 10 and having been reflected off the half-silvered mirror 20 passes through a position shifted from the optical axis Ax3R of the image forming optical system 30R. Specifically, the image forming optical system 30R is so disposed that when an imaginary light ray along the optical axis Ax3R of the image forming optical system 30R is incident on and reflected off the half-silvered mirror 20, the imaginary light ray travels along a line parallel to the optical axis Ax1 of the objective optical system 10 but shifted upward from the optical axis Ax1 by a distance Δ1. The image forming optical system 30L is so disposed that the optical axis Ax3L thereof is shifted from the optical axis Ax1 of the objective optical system 10 by a distance Δ2 on the opposite side of the optical axis Ax1 to distance Δ1 (downwardly vertical direction in FIG. 1A).

The image forming optical system 30R is also so disposed that the imaginary light ray traveling along the optical axis Ax3R and reflected off the half-silvered mirror 20 passes a position shifted horizontally rightward (upward in FIG. 1B) from the optical axis Ax1 of the objective optical system 10 by a distance Δ3, as shown in FIG. 1B. The image forming optical system 30L is also so disposed that the optical axis Ax3L thereof is shifted from the optical axis Ax1 of the objective optical system 10 by a distance Δ4 on the opposite side of the optical axis Ax1 to the distance Δ3 (downward in FIG. 1B).

It is now assumed that the thus configured stereoscopic imaging apparatus 1 is so disposed that the plane shown in FIG. 1B, which extends in the horizontal direction when the stereoscopic imaging apparatus 1 is viewed from above, is substantially parallel to a plane including a line connecting the eyes of a user of the stereoscopic imaging apparatus and extending in the horizontal direction. When the stereoscopic imaging apparatus 1 is disposed as described above, images acquired by the imaging devices 302R and 302L include a vertical parallax component produced by the distances Δ1 and Δ2 and a horizontal parallax component produced by the distances Δ3 and Δ4. Conversely, it is assumed that the stereoscopic imaging apparatus 1 is so disposed that the horizontal plane shown in FIG. 1B, which is a plane in the stereoscopic imaging apparatus 1 when viewed from above, perpendicularly intersects the plane including the line connecting the eyes of the user of the stereoscopic imaging apparatus and extending in the horizontal direction. In this case, images acquired by the imaging devices 302R and 302L include a horizontal parallax component produced by the distances Δ1 and Δ2 and a vertical parallax component produced by the distances Δ3 and Δ4.

### 1-2. Example of Configuration of Objective Optical System

An example of the configuration of the objective optical system 10 so configured that the a lens in the objective optical system 10 focuses the subject light to form a real image will next be described with reference to FIG. 2. It is assumed that the objective optical system 10 forms a real image for convenience of description, but the objective optical system 10 may form a virtual image. FIG. 2 shows the optical paths of light rays emitted from a subject S and passing through the center of an image forming lens 301R in the image forming optical system 30R and the center of an image forming lens 301L in the image forming optical system 30L. In FIG. 2, each of the objective optical system 10, the image forming optical system 30R, and the image forming optical system 30L is formed of a thin lens for ease of description.

Among the light rays emitted from three different points on the subject S, light rays to be incident on the center of the image forming lens 301R pass through the objective optical system 10 and are then focused again at points where they are reflected off the half-silvered mirror 20, as shown in FIG. 2. Let a spatial image S′R be an image of the subject S formed at the focused points in FIG. 2. On the other hand, among the light rays emitted from the three different points on the subject S, light rays to be incident on the center of the image forming lens 301L pass through the objective optical system 10 and are then focused again at points where they pass through the half-silvered mirror 20. Let a spatial image S′L be an image of the subject S formed at the focused points in FIG. 2.

The spatial images S′ formed by the objective optical system 10 are formed at a back focal point F1 of the objective optical system 10 when the subject S is located at infinity. When the subject S is located at a finite length, the spatial images S′ are formed in positions downstream of the back focal point (shifted toward imaging device 302R and 302L) in accordance with the distance from the objective optical system 10 to the subject S. The spatial images S′ are therefore formed within a range in the vicinity of the back focal point F1 of the objective optical system 10, as indicated as a spatial image formation region Ar shown in FIG. 2.

The spatial images S′ are recognized as if the subject were located in the positions of the spatial images S′ and can be viewed through the image forming lens 301R in the image forming optical system 30R and the image forming lens 301L in the image forming optical system 30L. The light rays having passed through the positions where the spatial images S′L and S′R shown in FIG. 2 are formed are guided through the image forming optical systems 30R and 30L and focused on the imaging surfaces (not shown) of the imaging devices 302R and 302L. The thus focused light rays form parallax images.

The light rays emitted from the subject S trace back the paths along which imaginary light rays emitted from the centers of the image forming lenses 301R and 301L follow. It is therefore helpful to consider light rays emitted from the centers of the image forming lenses 301R and 301L as well. The light rays emitted from the center of the image forming lens 301R or 301L pass through a certain point in the spatial image S′R (S′L), reach the lens in the objective optical system 10, and travel toward a certain point on the subject S that corresponds to the “certain point in the spatial image S′R (S′L).” In this process, the light rays having passed through the lens in the objective optical system 10 intersect one another again at a certain point before reaching the subject S.

That is, it can be said that the certain point is a point through which all the light rays that pass the centers of the image forming lens 301R and 301L pass. Video images formed on the imaging surface of the imaging device 302R and 302L are equivalent to images captured when the “certain point” works as a pupil. That is, the “certain point” is considered as a practical pupil in the stereoscopic imaging apparatus 1 (the practical pupil is hereinafter referred to as an “effective pupil” and described as “effective pupil EpL” or “effective pupil EpR” in FIG. 2).

The “effective pupil” is also formed when the lens in the objective optical system 10 receives light rays emitted from the subject S and outputs afocal light rays. FIGS. 3A and 3B show examples of the optical path of subject light traveling through the thus configured lens in the objective optical system 10 and incident on the image forming optical systems 30R and 30L. In the examples shown in FIGS. 3A and 3B, the objective optical system 10 includes a concave lens 11 and a convex lens 12.

FIG. 3A shows the optical paths of light rays having exited from a certain point on the subject S and incident on the image forming optical systems 30R and 30L. Among the light rays emitted from a point A, which is the certain point on the subject S, a light ray Ry1 that travels in parallel to the optical axis Ax1 of the objective optical system 10 reaches the concave lens 11 in the objective optical system 10 and then follows the path along which light travels straightforward from the a back focal point F2 of the concave lens 11 (in outward direction). Among the light rays emitted from the point A on the subject S, a light ray Ry2 that travels toward the center of the concave lens 11 remains traveling straightforward. Consider that an extension of the light ray Ry1 that exits through the concave lens 11 extends in the opposite direction to the direction in which the light ray Ry1 travels. The extension intersects the light ray Ry2. The intersection A′ where the extension intersects the light ray Ry2 is a point corresponding to the point A on the subject S and located in a virtual image S′ formed by the concave lens 11. All the light rays emitted from the point A on the subject S and passing through the concave lens 11 therefore travel as if they traveled straightforward from the point A′.

The light rays having passed through the concave lens 11 are converted by the convex lens 12 into substantially afocal light rays from the light rays emitted from the subject (subject light). Among the substantially afocal light rays converted from the subject light, the light rays reflected off the half-silvered mirror 20 are incident on the image forming optical system 30R and focused on the imaging surface of the imaging device 302R through the image forming lens 301R. Among the substantially afocal light rays converted from the subject light, the light rays having passed through the half-silvered mirror 20 are incident on the image forming optical system 30L and focused on the imaging surface of the imaging device 302L through the image forming lens 301L.

In FIG. 3A, the objective optical system 10 is configured to receive light rays from the subject S and output substantially afocal light rays, but the objective optical system 10 may alternatively be configured to form a virtual image of the subject S. Although not shown, when the objective optical system 10 is configured to form a virtual image, the light rays having passed through the concave lens 11 are converted by the convex lens 12 into a substantially divergent light flux. That is, the light rays are converted into a divergent light flux from the virtual image of the subject S formed by the objective optical system 10, which is the combination of the concave lens 11 and the convex lens 12. Light rays that form the substantially divergent light flux having exited from the objective optical system and reflected off the half-silvered mirror 20 are incident on the image forming optical system 30R and focused on the imaging surface of the imaging device 302R through the image forming lens 301R. Light rays that form the substantially divergent light flux having exited from the objective optical system and passing through the half-silvered mirror 20 are incident on the image forming optical system 30L and focused on the imaging surface of the imaging device 302L through the image forming lens 301L.

Returning to the description with reference to FIGS. 3A and 3B, FIG. 3B shows the optical paths of light rays emitted from the subject S and passing through the centers of the image forming lenses 301R and 301L. Among the light rays emitted from three different points on the subject S, light rays to be incident on the center of the image forming lens 301R or 301L are incident on and refracted by the concave lens 11 in the objective optical system 10 and travel outward. The effective pupils EpR and EpL are formed in positions somewhere along extensions of the light rays that enter the concave lens 11 and reach the principal plane thereof. Video images formed on the imaging surfaces of the imaging devices 302R and 302L are equivalent to images captured when the effective pupils EpR and EpL work as pupils. Both the examples shown in FIGS. 2, 3A, and 3B show that the effective pupils EpR and EpL are formed in positions shifted from the half-silvered mirror 20 toward the subject S.

On the other hand, in a stereoscopic imaging apparatus of related art in which a half-silvered mirror is disposed in front of cameras with no objective optical system, no “effective pupil” is formed. Images formed at the pupils of the cameras are directly formed on the imaging surfaces of the imaging devices. The half-silvered mirror is disposed in front of the pupils of the cameras (on the subject side), and a hood is attached to the half-silvered mirror. A subject located within a range equal to the sum of the length of the half-silvered mirror in the depth direction and the length of the hood is not naturally imaged. When the sum of the length of the half-silvered mirror in the depth direction and the length of the hood is, for example, 1 m, only a subject set apart from the pupil by at least 1 m can be imaged.

In contrast, according to the stereoscopic imaging apparatus 1 of the present embodiment of the present disclosure shown in FIGS. 2, 3A, and 3B, the spatial images S′ are formed in positions in the vicinity of the half-silvered mirror 20 or shifted from the half-silvered mirror 20 toward the subject S. In this case, stereoscopic images of even a near subject located in a position apart from the stereoscopic imaging apparatus 1 by about several centimeters can be captured.

When the lens in the objective optical system 10 is configured to form a real image as in the example shown in FIG. 2, each of the image forming lenses 301R and 301L needs to be a closeup lens. The reason for this is that the spatial images S′R (S′L) formed in positions very close to the image forming optical systems 30R and 30L need to be brought into focus. Since spatial images S′R (S′L) of a subject located at a typical distance that does not involve extreme closeup imaging are formed within a very narrow range, the image forming lenses 301R and 301L may only need to bring a narrow range comparable to the range within which the spatial images S′R (S′L) are formed into focus.

When the lenses in the objective optical system 10 receive light rays emitted from the subject S and outputs afocal light rays as in the example shown in FIGS. 3A and 3B, each of the image forming lenses 301R and 301L can be a typical lens. A typical lens used herein refers to a lens capable of bringing a subject located within a range from a typical shortest imaging distance to infinity into focus.

The zooming and focusing performed by the objective optical system 10 will next be described with reference to FIGS. 4A, 4B, 5A, and 5B. The objective optical system 10 shown in FIGS. 4A and 4B is assumed to be a typical zoom lens. FIGS. 4A and 4B show an example of the objective optical system 10 configured to be a two-group zoom lens having a zoom ratio of “2”. In the example shown in FIGS. 4A and 4B, the zoom lens (objective optical system 10) is formed of a concave lens 11 having a focal length of −87.5 mm and a convex lens 12 having a focal length of 44.9 mm.

As shown in FIG. 4A, when the distance from the imaging surface 1a to the principal plane of the convex lens 12 is set at 62.820 mm, and the distance from the principal plane of the convex lens 12 to the principal plane of the concave lens 11 is set at 69.550 mm, the focal length of the entire system becomes 35 mm. Further, as shown in FIG. 4B, when the distance from the imaging surface 1a to the principal plane of the convex lens 12 is set at 80.769 mm, and the distance from the principal plane of the convex lens 12 to the principal plane of the concave lens 11 is set at 13.460 mm, the focal length of the entire system becomes 70 mm.

Irrespective of the magnification factors described above, the focal position of the objective optical system 10 indicated by the intersection of the arrow representing the optical path of the subject light and the optical axis Ax1 is located on the imaging surface 1a and stays there across the zooming range. That is, the focal length of the entire system can be changed from 35 mm (wide-angle low magnification) to 70 mm (narrow-angle high magnification) by controlling the positions of the lenses in the objective optical system 10 without any change in the focal position, as shown in FIGS. 4A and 4B.

FIGS. 5A and 5B show an example of focus adjustment performed by using the two-group zoom lens shown in FIGS. 4A and 4B. FIGS. 5A and 5B show a case where focus adjustment is performed by changing only the position of the concave lens 11. FIG. 5A shows a case where only the concave lens 11 is moved toward the subject by −1 mm from a state in which subject light is focused on the imaging surface 1a. Moving the concave lens 11 as described above moves the focus position from the imaging surface 1a toward the subject by −0.12 mm. Alternatively, moving the concave lens 11 toward the imaging device by +1 mm moves the focus position from the imaging surface 1a toward the imaging device by +0.18 mm, as shown in FIG. 5B. Performing the focus adjustment thus moves spatial images. Using a zoom lens as the objective optical system 10 and performing focus adjustment by using the zoom lens is therefore substantially equivalent to changing the convergence position. That is, “focus adjustment” using the objective optical system 10 can in other words be “convergence adjustment.”

As described above, when the objective optical system 10 is configured to be a zoom lens formed of the concave lens 11 and the convex lens 12, the focal position (focus position) can be readily changed by moving the concave lens 11 forward or rearward along the optical axis Ax1. When focus adjustment is performed by moving only the concave lens 11, the focal length of the entire system also changes to 34.99 mm in the example shown in FIG. 5A or 35.3 mm in the example shown in FIG. 5B, although the amount of change is very small. The viewing angle also changes accordingly, but the amount of change is as small as 1%, which is believed to be practically negligible.

Focus adjustment can alternatively be made by moving the entire objective optical system 10 forward or rearward along the optical axis Ax1. The thus performed focus adjustment does not change the viewing angle. To this end, however, a large-scale mechanism for driving the objective optical system 10 is typically required. The examples shown in FIGS. 4A, 4B, 5A, and 5B have been described with reference to the case where the objective optical system 10 has both the zoom adjustment function and the focus adjustment function, but the objective optical system 10 may alternatively be configured to have only the zoom adjustment function or the focus adjustment function.

Further, according to the stereoscopic imaging apparatus 1 shown in FIGS. 1A and 1B to 5A and 5B, it is also possible to set a convergence point in an arbitrary position and then change the position of the convergence point (hereinafter also referred to as “convergence position”) by controlling only the objective optical system 10. The convergence position is set, for example, by shifting images provided from the imaging devices 302R and 302L from each other to form right and left parallax images and setting the convergence point in an arbitrary position in a region where the right and left parallax images overlap with each other. Alternatively, the convergence position can be set in an arbitrary position by shifting the positions themselves of the imaging devices 302R (302L) relative to the image forming optical systems 30R (30L) to form an overlap where the right and left parallax images overlap with each other and changing the amount of shift. When the latter method is used to set the convergence position, the number of pixels of each of the imaging devices 302R and 302L needs to be greater than the number of pixels of a display (not shown).

The thus set convergence position can be changed to a new position by moving the objective optical system 10 forward or rearward along the optical axis Ax1. For example, consider a case where the convergence position is changed to a new position in the stereoscopic imaging apparatus 1 shown in FIG. 2. When the entire objective optical system 10 is moved along the optical axis Ax1 thereof toward the subject S, the positions where the spatial images S′ are formed are also moved along the optical axis Ax1 toward the subject S accordingly. It is noted that the position where the convergence point is located does not change provided that the arrangement of the downstream imaging units 3L and 3R does not change. Moving the objective optical system 10 toward the subject S therefore moves the positions where the spatial images S′ are formed rearward (toward light-exiting side) relative to the position where the convergence point is located. That is, since the positions where the spatial images S′ are formed move in response to the translating motion of the objective optical system 10, the convergence position can be changed and moved to an arbitrary position in the spatial images S′ by controlling the amount of translating motion of the objective optical system 10.

When any of the lenses in the objective optical system 10 is a variable focal point optical element, the convergence position can be changed by using the variable focal length function. In this case, the positions where the spatial images S′ are formed are moved toward the subject S along the optical axis Ax1 of the objective optical system 10 by reducing the focal length of the objective optical system 10, whereas the positions where the spatial images S′ are formed are moved toward images along the optical axis Ax1 of the objective optical system 10 by increasing the focal length of the objective optical system 10.

As described above, according to the stereoscopic imaging apparatus 1 of the first embodiment of the present disclosure, zoom adjustment, focus adjustment, and convergence position adjustment can be made only by using the objective optical system 10, whereby the image forming optical system 30R or 30L does not need to have the functions described above. It is therefore unnecessary to perform ganged control of twin-lens cameras, which is performed at the time of focus and zoom adjustment in a stereoscopic imaging apparatus of related art. As a result, there is no relative shift between the twin-lens axes that occurs at the time of adjustment of the twin-lens cameras.

Further, since sophisticated control mechanisms and mechanical configurations for ganged control of the twin-lens cameras are not typically required, each of the lenses in the image forming optical systems 30R and 30L can be a monofunctional lens. The image forming optical systems 30R and 30L can therefore be reduced in size and cost. Moreover, since the size of the half-silvered mirror 20, which reflects or transmits light toward the image forming optical systems 30R and 30L can be reduced, the entire stereoscopic imaging apparatus 1 can be greatly reduced in size and manufacturing cost.

Further, according to the stereoscopic imaging apparatus 1 of the first embodiment of the present disclosure, since the half-silvered mirror 20 can be accommodated in an enclosure, no dirt will adhere to the half-silvered mirror 20.

Further, in the stereoscopic imaging apparatus 1 according to the first embodiment of the present disclosure, since light rays reflected off the half-silvered mirror 20 and light rays passing therethrough are incident on the image forming optical systems 30R and 30L respectively, the image forming optical systems 30R and 30L will not physically interfere with each other. The IAD can therefore be reduced to a very small value. When the image forming optical systems 30R and 30L are disposed coaxially, the IAD can be reduced to even zero.

Further, according to the stereoscopic imaging apparatus 1 of the first embodiment of the present disclosure, effective pupils are formed in positions in the vicinity of the half-silvered mirror 20 or shifted from the half-silvered mirror 20 toward the subject S, as described above. Video images formed on the imaging surfaces of the imaging devices 302R and 302L are equivalent to images captured when the effective pupils work as pupils. As a result, the distance between the “pupils” and the subject S is shorter than that in an imaging apparatus of related art. That is, the subject S can be imaged from a position closer to the subject S.

In the embodiment described above, the image forming optical systems 30R and 30L are so disposed that they are separated from each other by a predetermined distance in both the vertical and horizontal directions on opposite sides of the optical axis Ax1 of the objective optical system 10, but the image forming optical system 30R or 30L is not necessarily disposed this way. Alternatively, the image forming optical systems 30R and 30L may be so disposed that they are shifted from the optical axis Ax1 of the objective optical system 10 only in the vertical or horizontal direction.

For example, in the configuration shown in FIG. 1A as a side view, the image forming optical systems 30R and 30L can alternatively be so disposed that the distances Δ1 and Δ2 are zero. That is, the image forming optical systems 30R and 30L are so disposed that an imaginary light ray along the optical axis Ax3R of the image forming optical system 30R and the optical axis Ax3L of the image forming optical system 30L coincide with the optical axis Ax1 of the objective optical system 10, whereas in the configuration shown in FIG. 1B as a top view, the illustrated configuration is used as it is. That is, the horizontal position where the image forming optical system 30R is disposed is shifted rightward (upward in FIG. 1B) from the optical axis Ax1 of the objective optical system 10 by the distance Δ3, and the horizontal position where the image forming optical system 30L is disposed is shifted leftward (downward in FIG. 1B) from the optical axis Ax1 by the distance Δ4.

The thus configured stereoscopic imaging apparatus 1 is then so disposed that the horizontal plane in FIG. 1B as a top view is parallel to a plane including the line connecting the eyes of the user of the stereoscopic imaging apparatus and extending in the horizontal direction. In this case, parallax images provided from the imaging devices 302R and 302L contain no vertical parallax component but contain only a horizontal parallax component.

Conversely, the configuration shown in FIG. 1A as a side view can be used as it is, and in the configuration shown in FIG. 1B as a top view, the image forming optical systems 30R and 30L can be so disposed that the distances Δ3 and Δ4 are zero. In this case, parallax images provided from the imaging devices 302R and 302L contain no horizontal parallax component but contain only a vertical parallax component.

Further, the above embodiment has been described with reference to the case where the optical axis Ax1 of the objective optical system 10 and the optical axis Ax3R of the image forming optical system 30R are disposed in the same vertical plane shown in FIG. 1A, but the optical axes described above are not necessarily disposed this way. The half-silvered mirror 20 and the image forming optical system 30R may be disposed in positions rotated by an arbitrary angle around the optical axis Ax1 of the objective optical system 10. In this case, video images acquired by the imaging devices 302R and 302L contain the same horizontal and vertical parallax components recognized by the viewer as those acquired in the non-rotated configuration.

The axis around which the half-silvered mirror 20 and the image forming optical system 30R are rotated is not necessarily the optical axis Ax1 of the objective optical system 10 but may be any other suitable axis. For example, the path along which an imaginary light ray along the image forming optical system 30R travels after reflected off the half-silvered mirror 20 may be used as the axis around which the half-silvered mirror 20 and the image forming optical system 30R are rotated.

Still alternatively, not only the half-silvered mirror 20 and the image forming optical system 30R but also the image forming optical system 30L may be disposed in positions rotated by an arbitrary angle around the optical axis Ax1 of the objective optical system 10. In this configuration, video images acquired by the imaging devices 302R and 302L contain both horizontal and vertical parallax components recognized by the user even when the distances Δ1 to Δ4 shown in FIGS. 1A and 1B are all zero.

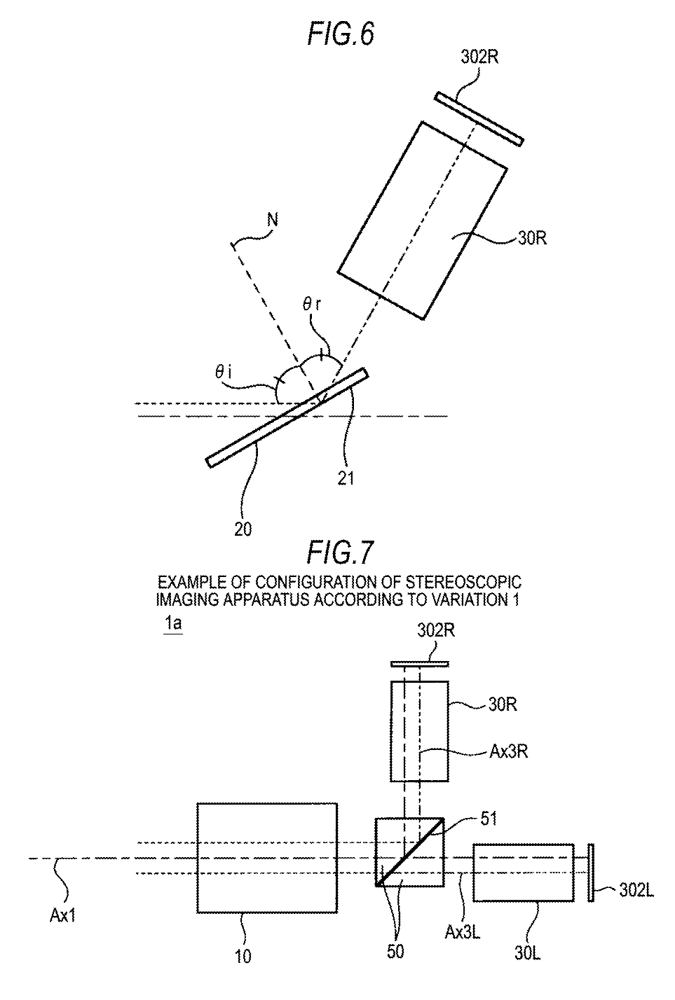

In the embodiment described above, the half-silvered mirror 20 is so angularly disposed that light rays traveling along the optical axis Ax1 of the objective optical system 10 is incident on the half-silvered mirror at an angle of incidence θi of 45 degrees, but the angle at which the half-silvered mirror 20 is disposed is not limited to 45 degrees. The half-silvered mirror 20 may be angularly disposed in any manner as long as the image forming optical system 30R is so disposed that the angle of incidence θi of subject light incident on the half-silvered mirror 20 is equal to the angle of reflection θr of the subject light incident on the image forming optical system 30R, as shown in FIG. 6. That is, the angle of the half-silvered mirror 20 may be set at any value as long as the angle of incidence θ of light rays traveling along the optical axis Ax1 of the objective optical system 10 and incident on the half-silvered mirror is greater than 0° but smaller than 180°. It is, however, noted that as the angle of incidence θ of light rays traveling along the optical axis Ax1 of the objective optical system 10 and incident on the half-silvered mirror increases, the area of the half-silvered mirror 20 (size of partially reflective surface 21) needs to be increased accordingly.

### 1-3. Variation 1

In the embodiment described above, the half-silvered mirror 20 is used as a separation optical system, but the separation optical system is not limited thereto. For example, a partially reflective film 51 sandwiched between transparent members 50 made, for example, of glass or transparent plastic may be used as the separation optical system. FIG. 7 shows an example of the configuration of a stereoscopic imaging apparatus 1a using the separation optical system described above. In FIG. 7, portions corresponding to those in FIGS. 1A and 1B have the same reference characters, and no redundant description will be made.

The configuration in which the partially reflective film 51 is covered with the transparent members 50 prevents dirt from adhering to the partially reflective film 51 and the partially reflective film 51 from being degraded. Further, combining the transparent members 50 into a cubic shape improves the rigidity thereof, whereby the shape of the reflective surface of the partially reflective film 51 is likely to be maintained. Shaping the separation optical system into a cubic shape further allows light rays guided through the objective optical system 10 to be incident on the light-incident surface of the transparent members 50 at right angles, whereby chromatic dispersion due to refraction does not tend to occur.

### 1-3. Variation 2

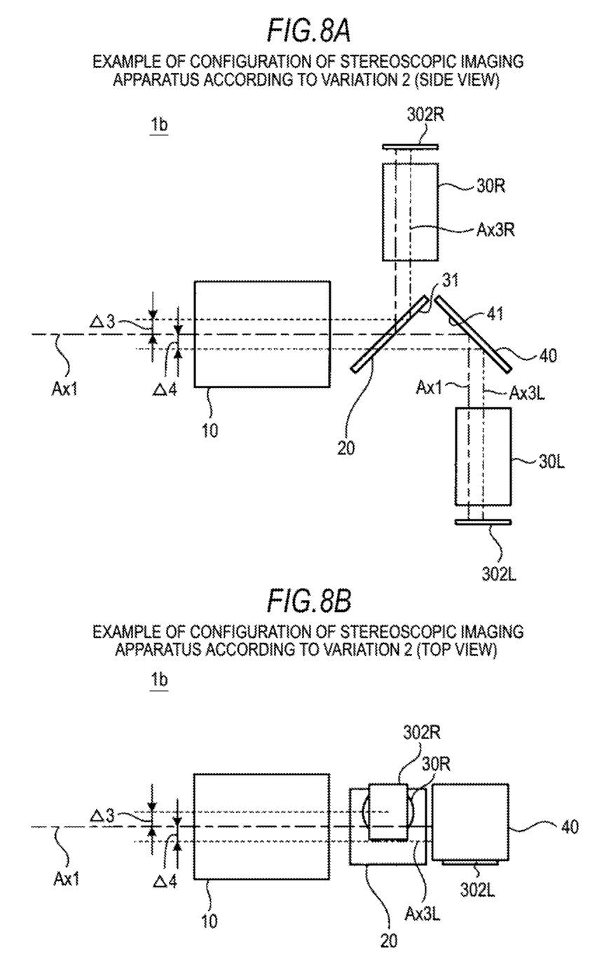

The embodiment described above has been described with reference to the case where the single half-silvered mirror 20 is used as the separation optical system, the separation optical system is not necessarily configured this way. For example, a mirror 40 that reflects light rays having passed through the half-silvered mirror 20 may be further provided. FIGS. 8A and 8B show an example of the configuration of a stereoscopic imaging apparatus 1b using the thus configured separation optical system. In FIGS. 8A and 8B, portions corresponding to those in FIGS. 1A, 1B, and 7 have the same reference characters, and no redundant description will be made. FIG. 8A is a side view of the stereoscopic imaging apparatus 1b, and FIG. 8B is a top view of the stereoscopic imaging apparatus 1b.

The mirror 40, which totally reflects light incident thereon, is so disposed that light rays having passed through the half-silvered mirror 20 are incident on the mirror 40, as shown in FIG. 8A. The mirror 40 is so angularly disposed that the light reflected off the mirror 40 travels in the direction reversed by 180° from the direction in which the light reflected off the half-silvered mirror 20 travels. Arranging the half-silvered mirror 20 and the mirror 40 as described above allows subject light guided through the objective optical system 10 to be reflected in rightward and leftward different directions. As a result, the positions where the image forming optical systems 30R and 30L are disposed can be reversed from each other by 180°, whereby a larger space is created around the image forming optical systems 30R and 30L than in the first embodiment. The degree of freedom in arranging the image forming optical systems 30R and 30L is greater than in the configuration shown in FIGS. 1A and 1B and other figures.

### 1-4. Variation 3

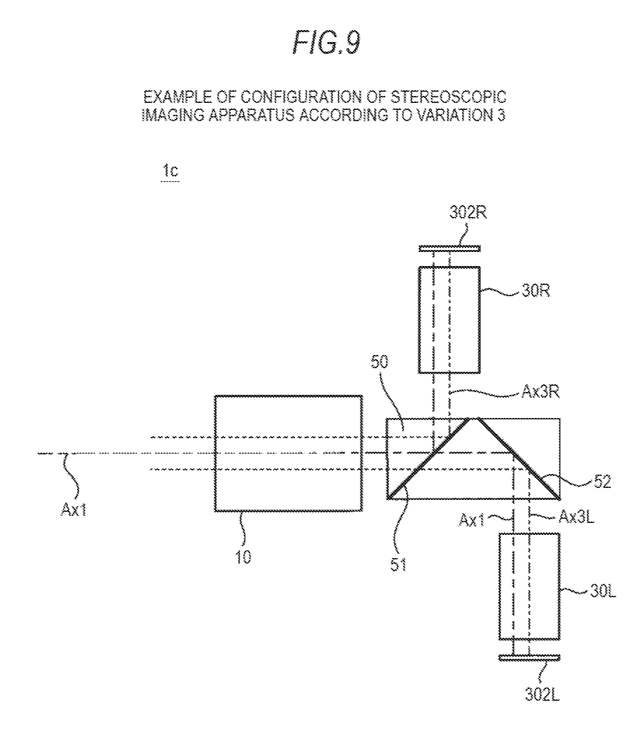

The separation optical system is not limited to the half-silvered mirror 20 and the mirror 40 but may be a partially reflective film 51 and a reflective film 52 sandwiched between transparent members 50, as illustrated in a stereoscopic imaging apparatus 1c shown in FIG. 9. The configuration prevents dirt from adhering to the partially reflective film 51 and the reflective film 52 and the partially reflective film 51 and the reflective film 52 from being degraded, as in the case of the configuration shown in FIG. 7. Further, combining the transparent members 50 into a substantially cubic shape improves the rigidity of thereof, whereby the shapes of the reflective surfaces of the partially reflective film 51 and the reflective film 52 are likely to be maintained. Shaping the separation optical system into a substantially cubic shape further allows light rays guided through the objective optical system 10 to be incident on the light-incident surface of the transparent members 50 at right angles, whereby chromatic dispersion due to refraction does not tend to occur.

### 2. Example of Configuration of Stereoscopic Imaging Apparatus According to Second Embodiment

### 2-1. Example of Configuration of Stereoscopic Imaging Apparatus

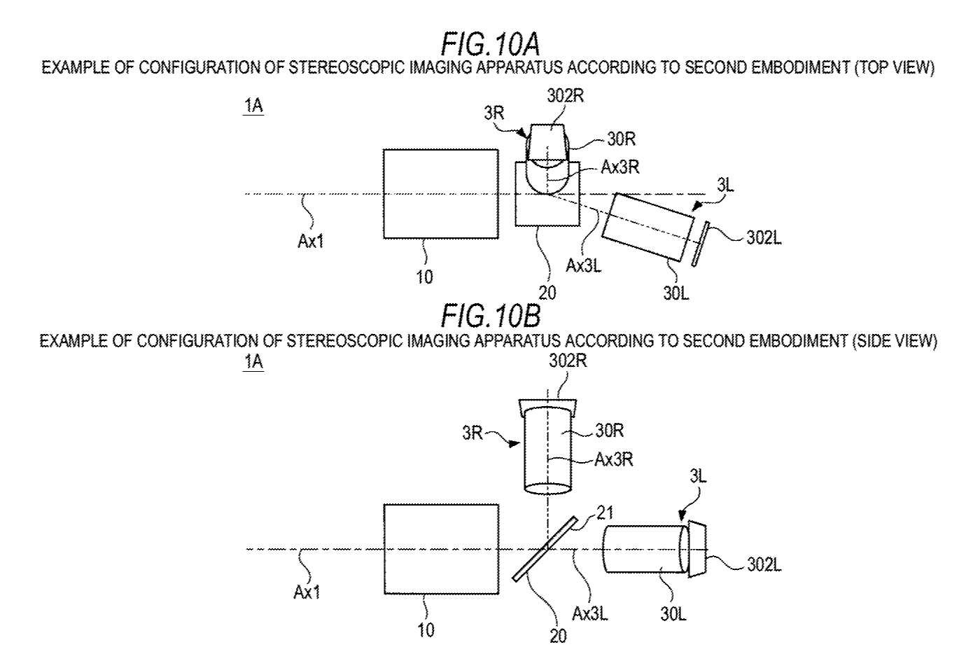

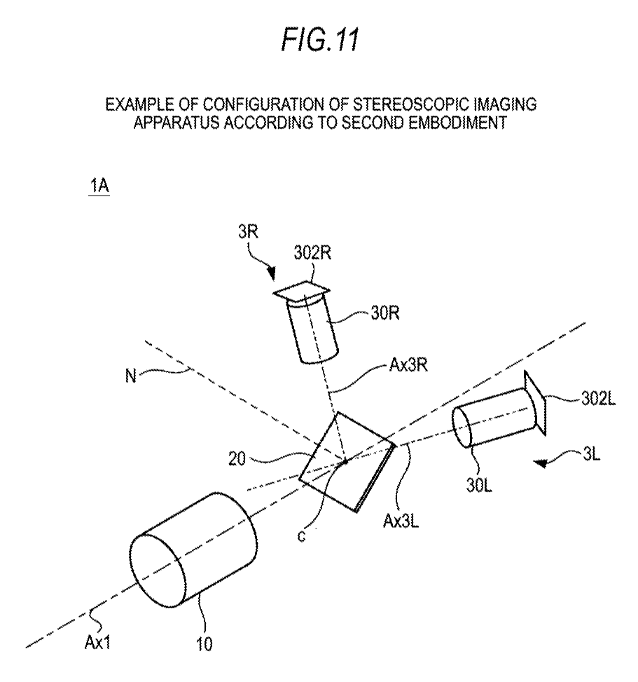

An example of the configuration of a stereoscopic imaging apparatus 1A according to a second embodiment of the present disclosure will next be described with reference to FIGS. 10A, 10B, and 11. FIG. 10A is a top view of the stereoscopic imaging apparatus 1A, and FIG. 10B is a side view of the stereoscopic imaging apparatus 1A. FIG. 11 is a perspective view of the stereoscopic imaging apparatus 1A. In FIGS. 10A, 10B, and 11, portions corresponding to those in FIGS. 1A and 1B have the same reference characters, and no redundant description will be made.

In the stereoscopic imaging apparatus 1A, the image forming optical systems 30R and 30L are so disposed that they are inclined inward, as shown in FIG. 10A. The inclination angles of the image forming optical systems 30R and 30L are so set that the optical axis Ax3R of the image forming optical system 30R and the optical axis Ax3L of the image forming optical system 30L intersect each other at a point on the half-silvered mirror 20 and on the optical axis Ax1 of the objective optical system 10. The point where the optical axis Ax3R of the image forming optical system 30R and the optical axis Ax3L of the image forming optical system 30L intersect each other is a convergence point c, as shown in FIG. 11.

Arranging the image forming optical systems 30R and 30L with a certain degree of convergence as described above allows the angle of incidence of off-axis light incident on the image forming optical systems to be reduced and the area of the common (overlapping) region between right and left parallax images formed by the imaging devices 302R and 302L to be readily adjusted. In particular, when a subject in the vicinity of the stereoscopic imaging apparatus 1A is imaged, the overlapping region between the right and left parallax images can be broadened by increasing the inclination angles (convergence angle) of the image forming optical systems 30R and 30L. In the overlapping region between the right and left parallax images, the subject is stereoscopically recognized. That is, according to the stereoscopic imaging apparatus 1A, a lens having a small angle of field of view can be used, whereby the area of the region of the subject that is desired to be stereoscopically displayed can be more readily adjusted.

The inclination angles of the image forming optical systems 30R and 30L can be set at arbitrary angles determined by a desired overlapping area between the right and left parallax images. It is noted that the inclination angles of the image forming optical systems 30R and 30L with respect to the optical axis Ax1 of the objective optical system 10 are not necessarily the same. For example, the optical axis Ax3R of the image forming optical system 30R and the optical axis Ax3L of the image forming optical system 30L may be so inclined that a primary subject that the user most desires to image is imaged at the centers of the imaging devices 302R and 302L.

The second embodiment described above can provide the same advantageous effects as those provided by the first embodiment.

In the stereoscopic imaging apparatus 1A shown in FIGS. 10A, 10B, and 11, the optical axis Ax3R of the image forming optical system 30R and the optical axis Ax3L of the image forming optical system 30L intersect each other at a point on the half-silvered mirror 20 and on the optical axis Ax1 of the objective optical system 10, but the image forming optical systems 30R and 30L are not necessarily configured this way. For example, the image forming optical systems 30R and 30L may alternatively be so disposed that the optical axis Ax3R of the image forming optical system 30R and the optical axis Ax3L of the image forming optical system 30L intersect each other in a position that is not located on the half-silvered mirror 20.

### 2-2. Variation 1

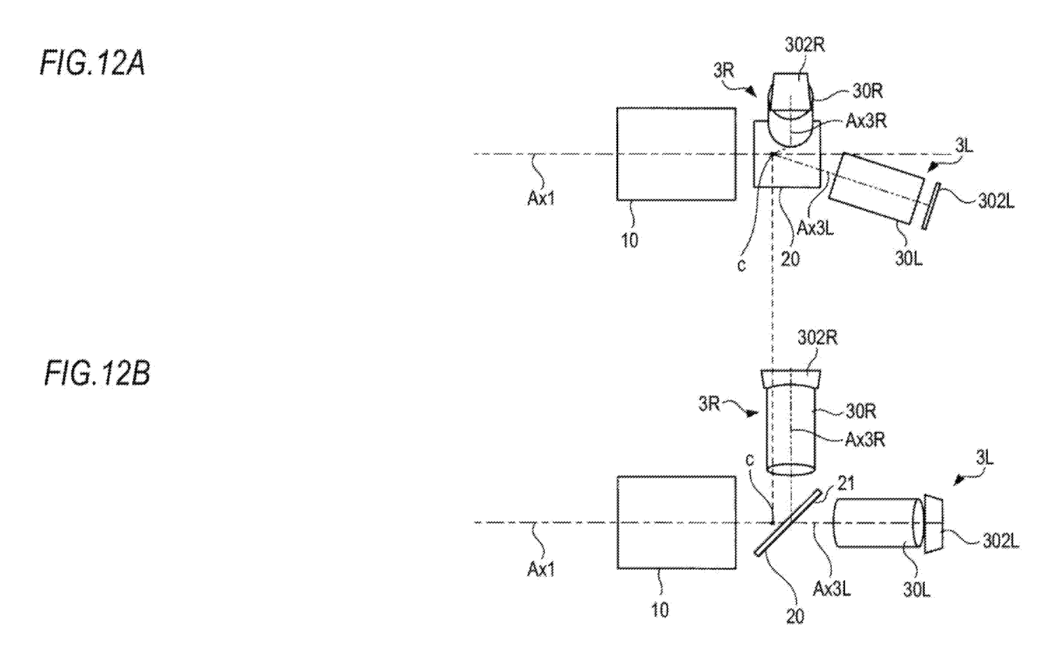

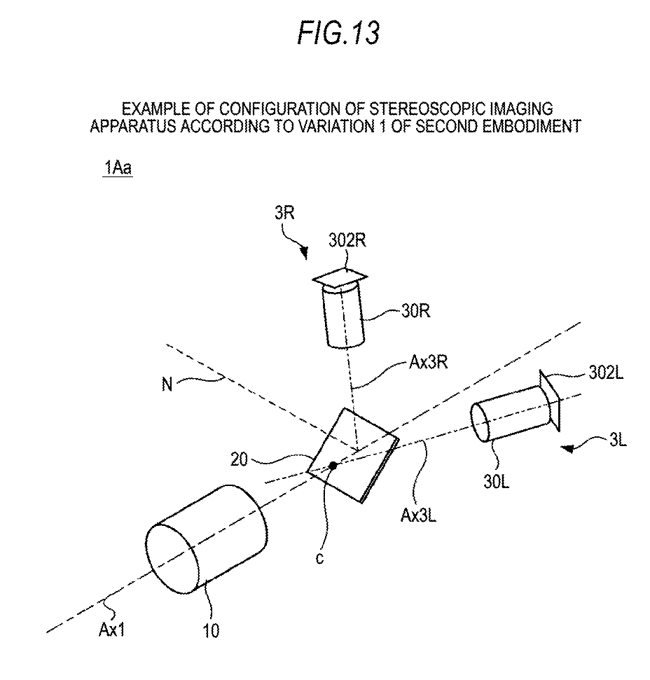

FIGS. 12A, 12B, and 13 show an example of the configuration of a stereoscopic imaging apparatus 1Aa configured as described above. FIG. 12A is a top view of the stereoscopic imaging apparatus 1Aa, and FIG. 12B is a side view of the stereoscopic imaging apparatus 1Aa. FIG. 13 is a perspective view of the stereoscopic imaging apparatus 1Aa. In FIGS. 12A, 12B, and 13, portions corresponding to those in FIGS. 1A, 1B, 10A, 10B, and 11 have the same reference characters, and no redundant description will be made.

An imaginary light ray along the optical axis Ax3R of the image forming optical system 30R exits out of the image forming optical system 30R, is then reflected off the half-silvered mirror 20, and travels along the optical axis Ax1 of the objective optical system 10, as shown in FIG. 13. On the other hand, an imaginary light ray along the optical axis Ax3L of the image forming optical system 30L passes through the half-silvered mirror 20 and then intersects the optical axis Ax1 of the objective optical system 10 before the imaginary light ray is incident on the objective optical system 10. That is, the light ray along the optical axis Ax3R of the image forming optical system 30R and the optical axis Ax3L of the image forming optical system 30L intersect each other at the point where the light ray along the optical axis Ax3L intersects the optical axis Ax1. The intersection, which is located on the optical axis Ax1 of the objective optical system 10 in the space between the objective optical system 10 and the half-silvered mirror 20, is a convergence point c in right and left parallax images.

### 2-3. Variation 2

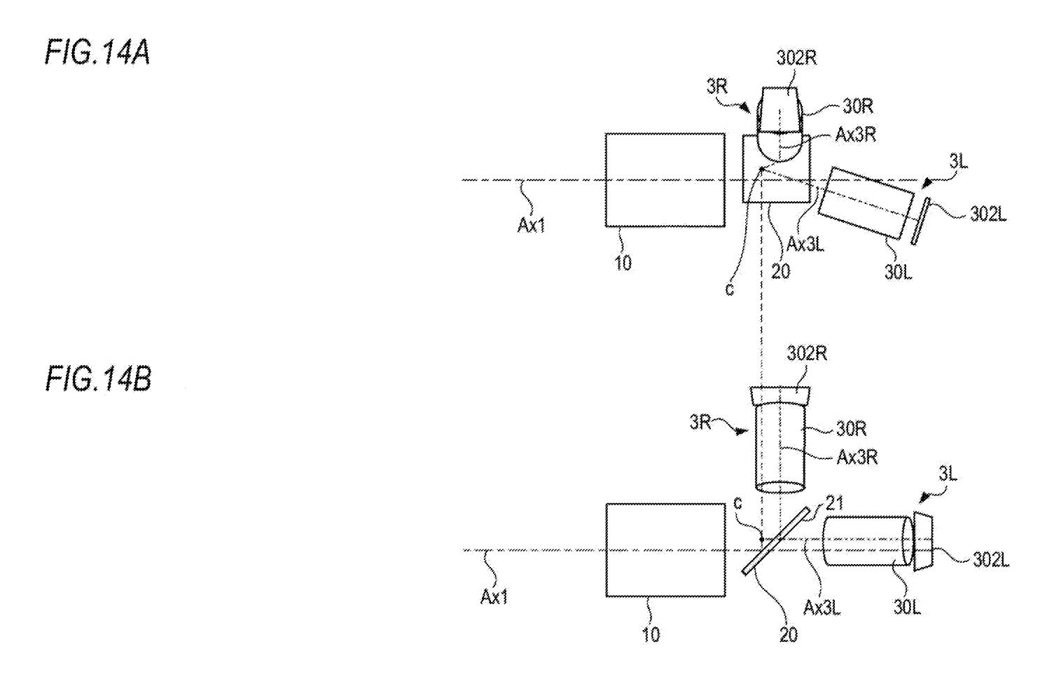

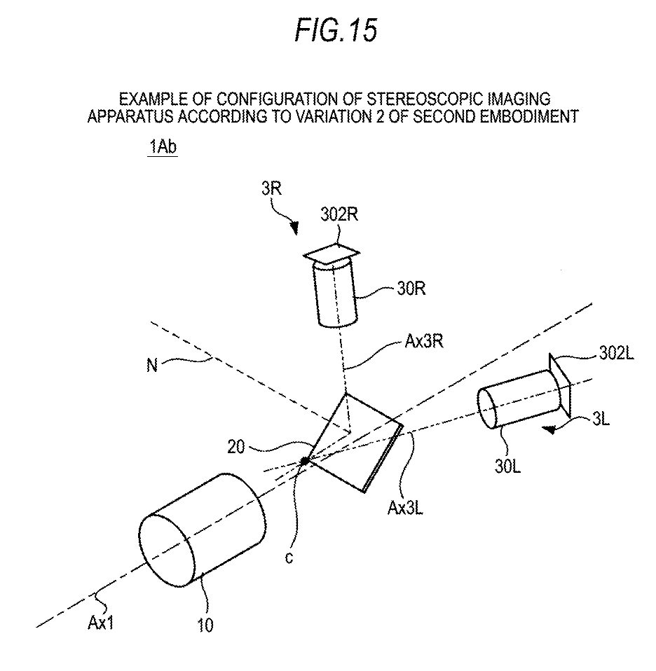

FIGS. 14A, 14B, and 15 show an example of the configuration of a stereoscopic imaging apparatus 1Ab so configured that a convergence point c in the stereoscopic imaging apparatus is located at a point that is located in the space between the objective optical system 10 and the half-silvered mirror 20 but is not located on the optical axis Ax1 of the objective optical system 10. FIG. 14A is a top view of the stereoscopic imaging apparatus 1Ab, and FIG. 14B is a side view of the stereoscopic imaging apparatus 1Ab. FIG. 15 is a perspective view of the stereoscopic imaging apparatus 1Ab. In FIGS. 14A, 14B, and 15, portions corresponding to those in FIGS. 1A, 1B, and 10A, 10B to 13 have the same reference characters, and no redundant description will be made.

In the stereoscopic imaging apparatus 1Ab, the image forming optical system 30R is so disposed that it is lifted by a predetermined distance from the position in the configuration shown in FIGS. 12A and 12B, as shown in FIG. 14B. As a result, an imaginary light ray along the optical axis Ax3R of the image forming optical system 30R is reflected off the half-silvered mirror 20 and then travels not along the optical axis Ax1 of the objective optical system 10 but along a line parallel thereto but slightly positioned upward. The image forming optical system 30L is also so disposed that the optical axis Ax3L thereof is parallel to the optical axis Ax1 of the objective optical system 10 but slightly positioned upward. As a result, an imaginary light ray along the optical axis Ax3R of the image forming optical system 30R and the optical axis Ax3L of the image forming optical system 30L intersect each other in a position above the optical axis Ax1 of the objective optical system 10 in the space between the objective optical system 10 and the half-silvered mirror 20, as shown in FIG. 15. The intersection is a convergence point c in right and left parallax images.

In the stereoscopic imaging apparatus 1Ab shown in FIGS. 14A, 14B, and 15, in which the image forming optical system 30L is so disposed that the optical axis Ax3L thereof is parallel to the optical axis Ax1 of the objective optical system 10, the image forming optical system 30L may alternatively be so disposed that the optical axis Ax3L thereof is not parallel to the optical axis Ax1.

In each of the configurations described in the second embodiment and the variations thereof, any of the configurations described in the variations of the first embodiment with reference to FIGS. 7 to 9 may be employed. That is, the separation optical system is not necessarily the half-silvered mirror 20 but may be the partially reflective film 51 sandwiched between the transparent members 50, the combination of the half-silvered mirror 20 and the mirror 40, or the partially reflective film 51 and the reflection film 52 covered with the transparent members 50.

### 3. Example of Configuration of Stereoscopic Imaging Apparatus According to Third Embodiment

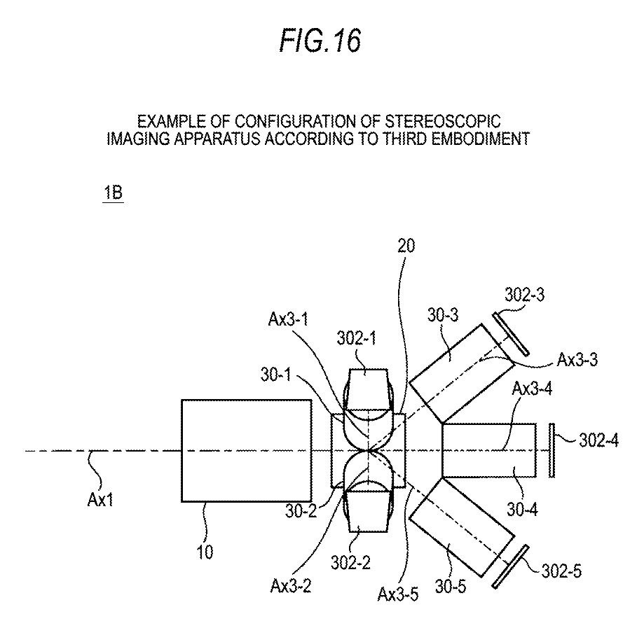

An example of the configuration of a stereoscopic imaging apparatus according to a third embodiment of the present disclosure will next be described with reference to FIG. 16. FIG. 16 is a top view of a stereoscopic imaging apparatus 1B viewed from above. In FIG. 16, portions corresponding to those in FIGS. 1A, 1B, 10A, 10B, 12A, 12B, 14A, 14B and other figures have the same reference characters, and no redundant description will be made.

The stereoscopic imaging apparatus 1B shown in FIG. 16 is an example of a stereoscopic imaging apparatus including five image forming optical systems 30 and imaging devices 302 corresponding thereto. In FIG. 16, the number of image forming optical systems 30 and imaging devices 302 corresponding thereto is five by way of example, but the number is not limited to five.

In the stereoscopic imaging apparatus 1B, image forming optical systems 30-1 to 30-5 are so angularly disposed that the optical axes Ax3-1 to Ax3-5 thereof intersect one another at a point on the half-silvered mirror 20 and on the optical axis Ax1 of the objective optical system 10.

The configuration described above allows the stereoscopic imaging apparatus 1B to acquire multi-parallax video images viewed in five different angular directions. Stereoscopic images and other types of image to be displayed on a multi-parallax-capable display can therefore be captured. Images used to interpolate parallax images can also be acquired. Acquiring images for interpolation solves “occlusion,” which leads to wrong interpretation because right and left images necessary for binocular stereoscopy are not related to each other.

The stereoscopic imaging apparatus 1B according to the third embodiment can also provide the same advantageous effects as those provided by the first embodiment.

The present disclosure can also be configured as follows.

(1) A stereoscopic imaging apparatus including

an objective optical system that acquires light rays emitted from a subject and guides the light rays to a downstream component,

a separation optical system having a partially reflective surface reflects part of the light rays guided through the objective optical system and transmits part thereof,

a first image forming optical system that is disposed on a path along which the light rays reflected off the separation optical system travel and focuses the reflected light rays to form a parallax image,

a second image forming optical system that is disposed on a path along which the light rays passing through the separation optical system travel and focuses the transmitted light rays to form a parallax image,

a first imaging device that converts the parallax image formed by the first image forming optical system into an image signal, and

a second imaging device that converts the parallax image formed by the second image forming optical system into an image signal.

(2) The stereoscopic imaging apparatus described in (1),

wherein the objective optical system has a focus adjustment function and/or a zoom adjustment function.

(3) The stereoscopic imaging apparatus described in (1) or (2),

wherein the first image forming optical system is so angularly disposed that the angle of incidence of a light ray incident on the partially reflective surface of the separation optical system is equal to the angle of reflection of the light ray reflected off the partially reflective surface of the separation optical system and incident along the optical axis of the first image forming optical system.

(4) The stereoscopic imaging apparatus described in any of (1) to (3),

wherein the first image forming optical system is so disposed that a path along which an imaginary light ray along the optical axis of the first image forming optical system travels after reflected off the separation optical system is substantially parallel to the optical axis of the objective optical system and that the path passes a position shifted from the optical axis of the objective optical system by a predetermined distance, and the second image forming optical system is so disposed that the optical axis of the second image forming optical system is substantially parallel to the optical axis of the objective optical system and that the optical axis of the second image forming optical system passes a position shifted by a predetermined distance from the optical axis of the objective optical system toward the opposite side to the first image forming optical system.

(5) The stereoscopic imaging apparatus described in any of (1) to (3),

wherein the first and second image forming optical systems are so angularly disposed that a path along which an imaginary light ray along the optical axis of the first image forming optical system travels after reflected off the separation optical system intersects the optical axis of the second image forming optical system at a point on the partially reflective surface of the separation optical system or in a space between the objective optical system and the separation optical system.

(6) The stereoscopic imaging apparatus described in any of (1) to (5),

wherein the separation optical system is formed of a half-silvered mirror.

(7) The stereoscopic imaging apparatus described in any of (1) to (5),

wherein the separation optical system is formed of a combination of a half-silvered mirror and a mirror that totally reflects light rays incident thereon.

(8) The stereoscopic imaging apparatus described in any of (1) to (5),

wherein the separation optical system is formed of a partially reflective film that reflects part of light rays incident thereon and transmits part thereof, and the partially reflective film is covered with a transparent member having a cubic shape.

(9) The stereoscopic imaging apparatus described in any of (1) to (5),

wherein the separation optical system is formed of a partially reflective film that reflects part of light rays incident thereon and transmits part thereof and a reflection film that totally reflects light rays incident thereon, and the partially reflective film and the reflection film are covered with a transparent member.

(10) The stereoscopic imaging apparatus described in any of (1) to (9),

wherein the objective optical system focuses light rays emitted from the subject to form a real or virtual image.

(11) The stereoscopic imaging apparatus described in any of (1) to (9),

wherein the objective optical system receives light rays emitted from the subject and outputs afocal light rays.

It should be understood by those skilled in the art that various modifications, combinations, sub-combinations and alterations may occur depending on design requirements and other factors insofar as they are within the scope of the appended claims or the equivalents thereof.

What is claimed is:

1. A stereoscopic imaging apparatus comprising:
an objective optical system that acquires light rays emitted from a subject and guides the light rays to a downstream component;
a separation optical system having a partially reflective surface that reflects part of the light rays guided through the objective optical system and transmits part thereof;
a first image forming optical system that is disposed on a path along which the light rays reflected off the separation optical system travel and focuses the reflected light rays to form a parallax image;
a second image forming optical system that is disposed on a path along which the light rays passing through the separation optical system travel and focuses the transmitted light rays to form a parallax image;
a first imaging device that converts the parallax image formed by the first image forming optical system into an image signal; and
a second imaging device that converts the parallax image formed by the second image forming optical system into an image signal.

2. The stereoscopic imaging apparatus according to claim 1,
wherein the objective optical system has a focus adjustment function and/or a zoom adjustment function.

3. The stereoscopic imaging apparatus according to claim 2,
wherein the first image forming optical system is so angularly disposed that the angle of incidence of a light ray incident on the partially reflective surface of the separation optical system is equal to the angle of reflection of the light ray reflected off the partially reflective surface of the separation optical system and incident along the optical axis of the first image forming optical system.

4. The stereoscopic imaging apparatus according to claim 3,
wherein the first image forming optical system is so disposed that a path along which an imaginary light ray along the optical axis of the first image forming optical system travels after reflected off the separation optical system is substantially parallel to the optical axis of the objective optical system and that the path passes a position shifted from the optical axis of the objective optical system by a predetermined distance, and the second image forming optical system is so disposed that the optical axis of the second image forming optical system is substantially parallel to the optical axis of the objective optical system and that the optical axis of the second image forming optical system passes a position shifted by a predetermined distance from the optical axis of the objective optical system toward the opposite side to the first image forming optical system.

5. The stereoscopic imaging apparatus according to claim 3,
wherein the first and second image forming optical systems are so angularly disposed that a path along which an imaginary light ray along the optical axis of the first image forming optical system travels after reflected off the separation optical system intersects the optical axis of the second image forming optical system at a point on the partially reflective surface of the separation optical system or in a space between the objective optical system and the separation optical system.

6. The stereoscopic imaging apparatus according to claim 3,
wherein the separation optical system is formed of a half-silvered mirror.

7. The stereoscopic imaging apparatus according to claim 3,
wherein the separation optical system is formed of a combination of a half-silvered mirror and a mirror that totally reflects light rays incident thereon.

8. The stereoscopic imaging apparatus according to claim 3,
wherein the separation optical system is formed of a partially reflective film that reflects part of light rays incident thereon and transmits part thereof, and the partially reflective film is covered with a transparent member having a cubic shape.

9. The stereoscopic imaging apparatus according to claim 3,
wherein the separation optical system is formed of a partially reflective film that reflects part of light rays incident thereon and transmits part thereof and a reflection film that totally reflects light rays incident thereon, and the partially reflective film and the reflection film are covered with a transparent member.

10. The stereoscopic imaging apparatus according to claim 3,
wherein the objective optical system focuses light rays emitted from the subject to form a real or virtual image.

11. The stereoscopic imaging apparatus according to claim 3,
wherein the objective optical system receives light rays emitted from the subject and outputs afocal light rays.
